(19) United States
(12) Patent Application Publication
(10) Pub. No.: US 2026/0128293 A1
(43) Pub. Date: May 7, 2026

(54) ANODE STRUCTURE AND METHOD OF PRODUCING AN ANODE STRUCTURE

(71) Applicants: ULVAC, INC., Chigasaki-shi (JP); INSTITUTE OF SCIENCE TOKYO, Tokyo (JP)

(72) Inventors: Takahito KIMOTO, Chigasaki-shi (JP); Shunsuke SASAKI, Chigasaki-shi (JP); Keisuke SHIMIZU, Tokyo (JP); Kuniharu NOMOTO, Tokyo (JP); Ryoji KANNO, Tokyo (JP)

(21) Appl. No.: 19/381,797

(22) Filed: Nov. 6, 2025

(30) Foreign Application Priority Data
Nov. 7, 2024 (JP) 2024-194907

(51) Int. Cl. H01M 4/40; H01M 4/02; H01M 4/04; H01M 4/1395; H01M 4/36; H01M 10/0525

(52) U.S. Cl. CPC H01M 4/405; H01M 4/0404; H01M 4/1395; H01M 4/366; H01M 10/0525; H01M 2004/021; H01M 2004/027

(57) ABSTRACT

An anode structure according to an embodiment of the present disclosure is an anode structure applied to an anode of a lithium-ion secondary battery. The anode structure includes: an anode current collector, and a lithium alloy layer formed on the anode current collector. The lithium alloy layer has a stoichiometric composition represented by the formula Li_{1-x-y}BiₓMg_{y} (0<x+y≤0.124, 0≤x≤0.024, 0<y≤0.10), and the lithium alloy layer has a thickness of 1 μm or more and 20 μm or less.

### CROSS-REFERENCE TO RELATED APPLICATION

This application claims the benefit of Japanese Application No. 2024-194907, filed Nov. 7, 2024, the entire contents of which are incorporated herein by reference.

### FIELD

The present disclosure relates to an anode structure applied to a lithium-ion secondary battery, and a method of producing an anode structure.

### BACKGROUND

With the advancement of mobile devices such as mobile phones and smartphones, attention has been focused on lithium-ion secondary batteries mounted on these devices. In such lithium batteries, a lithium metal layer as an anode structure is formed on an anode current collector (see, for example, Japanese Patent Application Laid-open No. 2012-017478).

### SUMMARY

In recent years, attention has been focused on all-solid batteries in which the electrolyte is solid, as the above lithium-ion secondary batteries. In such all-solid batteries, for example, attempts have been made to increase the volumetric energy density (W·h/L) of the battery by reducing the thickness of the lithium metal layer.

However, reducing the thickness of the lithium metal layer causes, for example, dendrite growth from the lithium metal layer toward the solid electrolyte layer or peeling between the lithium metal layer and the solid electrolyte layer in some cases, which shortens the cycle life of the lithium-ion secondary battery due to deterioration of the lithium metal layer in some cases.

In view of the circumstances as described above, it is desired to provide an anode structure that allows the cycle life of the lithium-ion secondary battery to be made longer, and a method of producing the same.

According to an embodiment of the present disclosure, there is provided an anode structure applied to an anode of a lithium-ion secondary battery.

The anode structure includes: an anode current collector; and a lithium alloy layer formed on the anode current collector.

The lithium alloy layer has a stoichiometric composition represented by the formula Li_{1-x-y}BiₓMg_{y} (0<x+y≤0.124, 0≤x≤0.024, 0<y≤0.10), and
the lithium alloy layer has a thickness of 1 μm or more and 20 μm or less.

With such an anode structure, it is possible to make the cycle life of the lithium-ion secondary battery longer.

In the anode structure, the lithium alloy layer may have a Young's modulus of 4 GPa or more and 30 GPa or less.

With such an anode structure, it is possible to make the cycle life of the lithium-ion secondary battery longer.

In the anode structure, the lithium alloy layer may have relative density of 80% or more.

With such an anode structure, it is possible to make the cycle life of the lithium-ion secondary battery longer.

In the anode structure, the lithium alloy layer may include a layer with a relatively large content of bismuth.

With such an anode structure, it is possible to make the cycle life of the lithium-ion secondary battery longer.

According to an embodiment of the present disclosure, there is provided a method of producing an anode structure applied to an anode of a lithium-ion secondary battery.

The method of producing an anode structure includes:
forming one of a lithium-containing layer and a modification layer on an anode current collector; and
forming, after forming the one layer, the other of the lithium-containing layer and the modification layer on the one layer,
a magnesium layer, a bismuth layer, a layer containing lithium and magnesium, or a layer containing magnesium and bismuth being used as the modification layer.

An alloy layer has a stoichiometric composition represented by the formula Li_{1-x-y}BiₓMg_{y} (0<x+y≤0.124, 0≤x≤0.024, 0<y≤0.10), the alloy layer being formed on the anode current collector and including the lithium-containing layer and the modification layer, and
the alloy layer has a thickness of 1 μm or more and 20 μm or less.

With such a production method, it is possible to make the cycle life of the lithium-ion secondary battery longer.

In the method of producing an anode structure, the lithium-containing layer may contain magnesium.

With such a production method, it is possible to make the cycle life of the lithium-ion secondary battery longer.

The method of producing an anode structure may further include
depositing, where the layer containing magnesium and bismuth is used as the modification layer, one material of magnesium and bismuth and then depositing the other material of magnesium and bismuth.

With such a production method, it is possible to make the cycle life of the lithium-ion secondary battery longer.

According to an embodiment of the present disclosure, there is provided an anode structure that allows the cycle life of the lithium-ion secondary battery to be made longer, and a method of producing the same.

### BRIEF DESCRIPTION OF FIGURES

FIG. 1 is a schematic cross-sectional view showing an example of an anode structure according to this embodiment;

FIGS. 2A-2D are schematic cross-sectional views showing an example of a method of producing an anode structure according to this embodiment;

FIGS. 3A-3D are schematic cross-sectional views showing another example of the method of producing an anode structure according to this embodiment;

FIGS. 4A-4C are schematic cross-sectional views showing still another example of the method of producing an anode structure according to this embodiment;

FIGS. 5A and 5B are schematic cross-sectional views showing a high-concentration bismuth layer in a lithium alloy layer; and

FIG. 6 is a graph diagram showing an example of the effects of this embodiment.

### DETAILED DESCRIPTION

Hereinafter, embodiments of the present disclosure will be described with reference to the drawings. Further, the same members or members having the same function will be denoted by the same reference symbols in some cases, and the description will be omitted as appropriate in some cases after describing the members. Further, numerical values shown below are examples and the present disclosure is not limited to these examples.

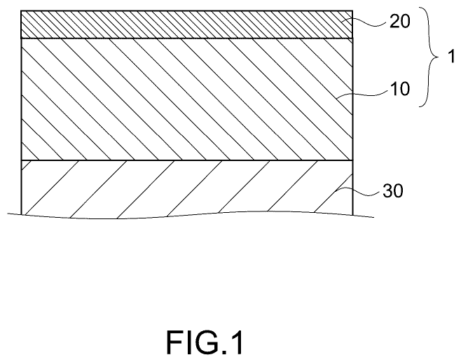

FIG. 1 is a schematic cross-sectional view showing an example of an anode structure according to this embodiment. An anode structure 1 shown in FIG. 1 is applied to, for example, the anode of an all-solid lithium-ion secondary battery. In the example of FIG. 1, a solid electrolyte layer 30 that is in contact with the anode structure 1 is shown in addition to the anode structure 1.

The anode structure 1 includes a lithium alloy layer 10 and an anode current collector 20. The lithium alloy layer 10 functions as the lithium source in the lithium-ion secondary battery. The lithium alloy layer 10 is formed on the anode current collector 20. Further, the lithium alloy layer 10 is provided between the anode current collector 20 and the solid electrolyte layer 30.

The lithium alloy layer 10 contains not only lithium (Li) but also magnesium (Mg). Further, the lithium alloy layer 10 may contain bismuth (Bi). The lithium alloy layer 10 has a stoichiometric composition represented by the formula Li_{1-x-y}BiₓMg_{y} (0<x+y≤0.124, 0≤x≤0.024, 0<y≤0.10). The numbers at the bottom right of each element symbol indicate the equivalent, the ratio of the number of moles in the lithium alloy layer 10, or the ratio of the number of atoms in the lithium alloy layer 10. Further, the lithium alloy layer 10 has a thickness of 1 μm or more and 20 μm or less.

Even if the lithium alloy layer 10 has a thickness of 1 μm or more and 20 μm or less, when x+y>0.124, x>0.024, or y>0.10, it is undesirable because the desired cycle life of the lithium-ion secondary battery cannot be achieved.

Further, even if the lithium alloy layer 10 has a stoichiometric composition represented by the formula Li_{1-x-y}BiₓMg_{y} (0<x+y≤0.124, 0≤x≤0.024, 0<y≤0.10), when the lithium alloy layer 10 has a thickness of less than 1 μm, it is undesirable because a continuous film cannot be formed, and when the lithium alloy layer 10 has a thickness of larger than 20 μm, it is undesirable because the productivity becomes poor.

Further, the thickness of the lithium alloy layer 10 is more favorably 1 μm or more and 10 μm or less, still more favorably 1 μm or more and 5 μm or less. When the thickness of the anode structure 1 is reduced, it is desirable because the volumetric energy density (W·h/L) of the lithium-ion secondary battery is further improved.

Further, the lithium alloy layer 10 has a Young's modulus of 4 GPa or more and 30 GPa or less. The Young's modulus is measured by, for example, a nanoindentation method. When the Young's modulus of the lithium alloy layer 10 is less than 4 GPa, it is undesirable because there is a risk of short circuiting in the lithium alloy layer 10 due to dendrite growth, and when the Young's modulus of the lithium alloy layer 10 is greater than 30 GPa, it is undesirable because the moldability of the lithium alloy layer 10 becomes poor and there is a risk of poor contact with the solid electrolyte. Further, the Young's modulus of the lithium alloy layer 10 is more favorably 10 GPa or more and 25 GPa or less, still more favorably 15 GPa or more and 20 GPa or less.

Further, the lithium alloy layer has relative density ((measured density/theoretical density)×100(%)) of 80% or more. The measured density is obtained from, for example, film thickness measurement and ICP optical emission spectrometry. When the relative density of the lithium alloy layer 10 is less than 80%, it is undesirable because the effective utilization rate of lithium is reduced. Further, the relative density of the lithium alloy layer 10 is more favorably 85% or more, still more favorably 90% or more.

In the lithium alloy layer 10, the presence of magnesium mixed with lithium improves, for example, mainly the mechanical strength of the lithium alloy layer 10, as compared with the case where the lithium alloy layer 10 is formed of pure lithium. Further, in the lithium alloy layer 10, the presence of bismuth mixed with lithium improves, for example, mainly the wettability of the lithium alloy layer 10 in the solid electrolyte layer 30, as compared with the case where the lithium alloy layer 10 is formed of pure lithium. Further, in the lithium alloy layer 10, the presence of at least one of magnesium or bismuth mixed with lithium increases, for example, mainly the electrode potential of the lithium-ion secondary battery and suppresses the reduction (decomposition) of the solid electrolyte layer 30, as compared with the case where the lithium alloy layer 10 is formed of pure lithium. Note that these effects are merely examples, and the effects achieved by adding magnesium or bismuth to lithium are not limited to the above.

As a result, in the anode structure 1 according to this embodiment, the dendrite growth from the lithium alloy layer 10 to the solid electrolyte layer 30 is suppressed, the void formation in the lithium alloy layer 10 is suppressed, the peeling between the lithium alloy layer 10 and the solid electrolyte layer 30 is suppressed, or the interfacial chemical reaction between the lithium alloy layer 10 and the solid electrolyte layer 30 is suppressed. As a result, the cycle life of the lithium-ion secondary battery in which the anode structure 1 is incorporated is significantly improved.

The anode current collector 20 is, for example, a copper (Cu) foil, a nickel (Ni) foil, an iron (Fe) foil, or an alloy foil containing at least two of copper, nickel, and iron. The anode current collector 20 may also be a stainless steel (SUS) foil. Further, the solid electrolyte layer 30 is, for example, a sulfide-based solid electrolyte layer. Examples of the sulfide include Li₃PS₄, Li₆PS₅X (X=one of Cl, Br, and I), and Li₁₀GeP₂S₁₂.

An example of the method of producing the anode structure 1 will be described below.

In this embodiment, one of a lithium-containing layer and a modification layer is formed on an anode current collector, and after forming the one layer, the other of the lithium-containing layer and the modification layer is formed on the one layer. As the modification layer, a magnesium layer, a bismuth layer, a layer containing lithium and magnesium, or a layer containing magnesium and bismuth is used. Here, the lithium-containing layer may contain magnesium.

Further, in the case where the layer containing magnesium and bismuth is used as the modification layer, after depositing one material of magnesium and bismuth, the other material of magnesium and bismuth may be deposited.

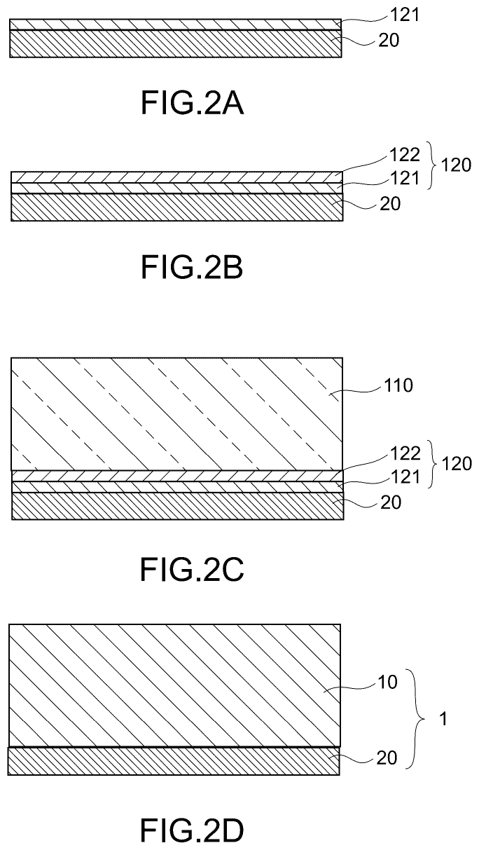

FIG. 2A to FIG. 2D are each a schematic cross-sectional view showing an example of the method of producing an anode structure according to this embodiment. In this embodiment, for example, a sputtering method is applied as the method of depositing a layer. In the sputtering method, a sputtering target formed of the corresponding metal or alloy is used. The deposition method is not limited to the sputtering method and may be a vapor deposition method.

For example, as shown in FIG. 2A, a magnesium layer 121 is formed on the anode current collector 20. The magnesium layer 121 has a film thickness of 50 nm or more and 600 nm or less. Next, as shown in FIG. 2B, a bismuth layer 122 is formed on the magnesium layer 121. The bismuth layer 122 has a film thickness of 50 nm or more and 200 nm or less. In this way, a modification layer 120 containing magnesium and bismuth is formed on the anode current collector 20.

Here, after forming the bismuth layer 122 on the anode current collector 20, the magnesium layer 121 may be formed on the bismuth layer 122. That is, the order of stacking the magnesium layer 121 and the bismuth layer 122 on the anode current collector 20 may be such that the magnesium layer 121 is stacked first or the bismuth layer 122 is stacked first. Further, the modification layer 120 may be formed in one step using an alloy target containing magnesium and bismuth. Further, either the formation of the magnesium layer 121 or the formation of the bismuth layer 122 may be omitted.

Next, as shown in FIG. 2C, a lithium-containing layer 110 is formed on the modification layer 120. For example, a pure lithium metal layer is applied as the lithium-containing layer 110 shown in FIG. 2C. The lithium-containing layer 110 has a film thickness of 1 μm or more and 20 μm or less.

After that, the components of the modification layer 120 are diffused (at room temperature) into the lithium-containing layer 110 to form the lithium alloy layer 10 on the anode current collector 20 as shown in FIG. 2D. In this way, the anode structure 1 is formed.

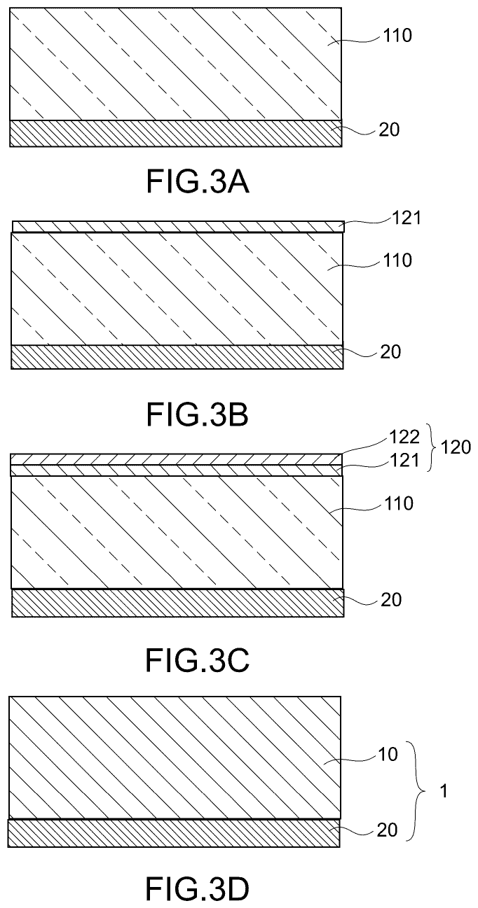

FIG. 3A to FIG. 3D are each a schematic cross-sectional view showing another example of the method of producing an anode structure according to this embodiment.

For example, as shown in FIG. 3A, the lithium-containing layer 110 is formed on the anode current collector 20. For example, a pure lithium metal layer is applied as the lithium-containing layer 110 shown in FIG. 3A. The lithium-containing layer 110 has a film thickness of 1 μm or more and 20 μm or less. Next, as shown in FIG. 3B, the magnesium layer 121 is formed on the lithium-containing layer 110. The magnesium layer 121 has a film thickness of 50 nm or more and 600 nm or less. Next, as shown in FIG. 3C, the bismuth layer 122 is formed on the magnesium layer 121. The bismuth layer 122 has a film thickness of 50 nm or more and 200 nm or less. In this way, the modification layer 120 containing magnesium and bismuth is formed on the lithium-containing layer 110.

Here, after forming the bismuth layer 122 on the lithium-containing layer 110, the magnesium layer 121 may be formed on the bismuth layer 122. That is, the order of stacking the magnesium layer 121 and the bismuth layer 122 on the lithium-containing layer 110 may be such that the magnesium layer 121 is stacked first or the bismuth layer 122 is stacked first. Further, the modification layer 120 may be formed in one step using an alloy target containing magnesium and bismuth. Further, either the formation of the magnesium layer 121 or the formation of the bismuth layer 122 may be omitted.

After that, the components of the modification layer 120 are diffused (at room temperature) into the lithium-containing layer 110 to form the lithium alloy layer 10 on the anode current collector 20 as shown in FIG. 3D. In this way, the anode structure 1 is formed.

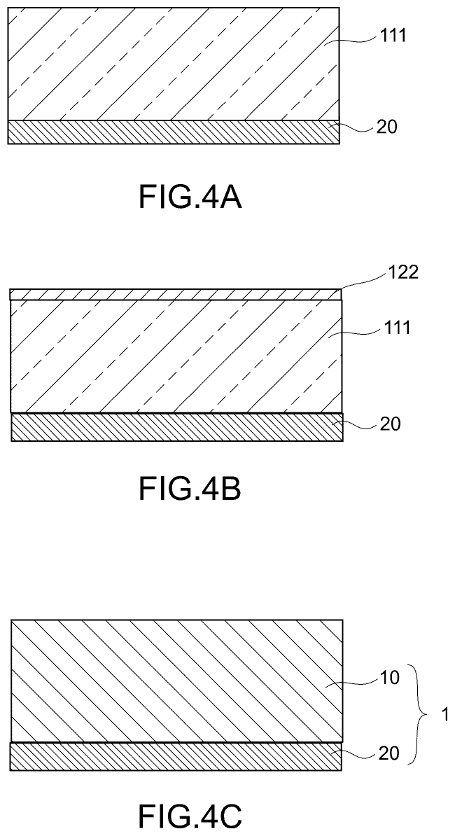

FIG. 4A to FIG. 4C are each a schematic cross-sectional view showing still another example of the method of producing an anode structure according to this embodiment.

For example, as shown in FIG. 4A, a lithium-containing layer 111 is formed on the anode current collector 20. For example, a layer in which magnesium is added to pure lithium is applied as the lithium-containing layer 111 shown in FIG. 4A. For example, the lithium-containing layer 111 is formed using an alloy target containing lithium and magnesium. The lithium-containing layer 111 has a film thickness of 1 μm or more and 20 μm or less. Next, as shown in FIG. 4B, the bismuth layer 122 is formed on the lithium-containing layer 111. The bismuth layer 122 has a film thickness of 50 nm or more and 200 nm or less. In this way, the modification layer including the bismuth layer 122 is formed on the lithium-containing layer 111.

Here, the order of stacking the lithium-containing layer 111 and the bismuth layer 122 on the anode current collector 20 may be such that the lithium-containing layer 111 is stacked first or the bismuth layer 122 is stacked first. Further, the formation of the bismuth layer 122 may be omitted.

After that, the components of the bismuth layer 122 are diffused (at room temperature) into the lithium-containing layer 111 to form the lithium alloy layer 10 on the anode current collector 20 as shown in FIG. 4C. In this way, the anode structure 1 is formed.

The diffusion of magnesium or bismuth in the lithium-containing layer 110 and the diffusion of bismuth in the lithium-containing layer 111 have been confirmed by, for example, energy-dispersive X-ray analysis (EDX analysis) of the cross section of the lithium alloy layer 10. Further, the stoichiometric ratio of the lithium alloy layer 10 is calculated using the thicknesses (μm), atomic weights (g/mol), and volume density (g/cm³) of the lithium-containing layers 110 and 111, the magnesium layer 121, and the bismuth layer 122. Here, the stoichiometric ratio was calculated with the atomic weights and volume densities of Li, Mg, and Bi as 6.941, 24.305, and 208.98 g/mol and 0.534, 1.738, and 9.78 g/cm³, respectively.

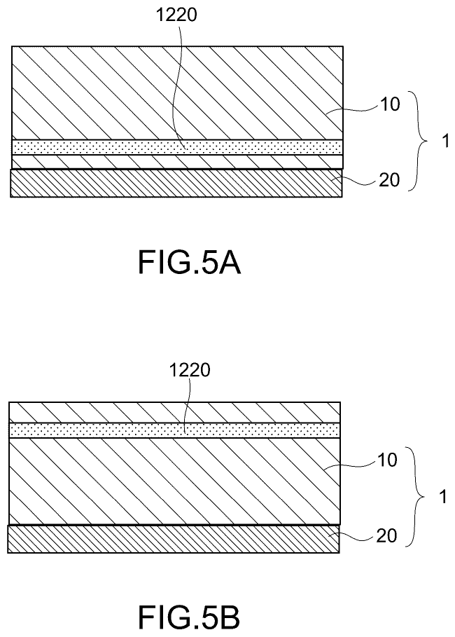

Note that bismuth is less likely to diffuse in the lithium metal layer than magnesium. For this reason, in the lithium alloy layer 10, a layer with a relatively large content (atomic %) of bismuth is formed in some cases. For example, through the deposition process shown in FIG. 2A to FIG. 2C, a high-concentration bismuth layer 1220 with a relatively large content of bismuth is formed in some cases in the vicinity of the anode current collector 20 as shown in FIG. 5A. Further, through the deposition process shown in FIG. 3A to FIG. 3C, the high-concentration bismuth layer 1220 is formed in some cases in the vicinity of the surface of the lithium alloy layer 10 on the side opposite to the anode current collector 20 as shown in FIG. 5B. Such a configuration has been confirmed by EDX analysis of the cross section of the lithium alloy layer 10.

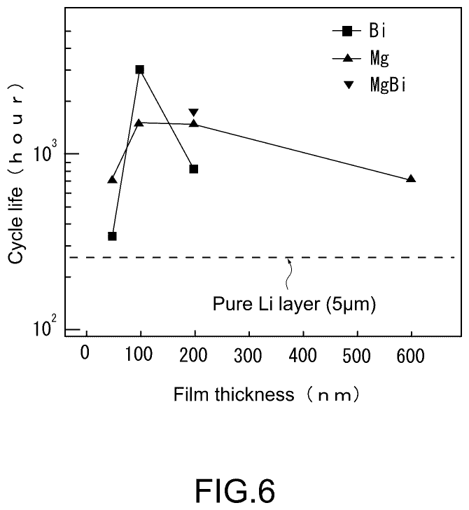

FIG. 6 is a graph diagram showing an example of the effects of this embodiment. The horizontal axis indicates the film thickness (nm), and the vertical axis indicates the cycle life (hour) of the evaluation sample.

As the evaluation sample, a stacked body including an A layer: a current collector (SUS foil)/a B layer: a pure Li layer (film thickness of 100 μm)/a C layer: a sulfide solid electrolyte layer/a D layer: a pure Li layer (film thickness of 5 μm)/an E layer: a modification layer/an F layer: a current collector (SUS foil) is used. Here, the A layer and the B layer correspond to the counter electrode side, and the D layer, the E layer, and the F layer correspond to the working electrode side. For example, the D layer, the E layer, and the F layer are formed in accordance with the production method according to this embodiment, and the A layer, the B layer, and the C layer are laminated onto them. Note that as described above, the order of stacking the D layer and the E layer is reversed in some cases.

In the evaluation, the stacked body was subjected to a charge/discharge cycle test. For example, applying a current set to +0.3 mA/cm² and applying a current set to −0.3 mA/cm² were alternately repeated for every 60 minutes, and the voltage at this time was measured. The time when the voltage became unstable and dropped sharply or when the voltage swung due to the repeated charging/discharging was used as the cycle life of the evaluation sample.

In FIG. 6, as Comparative Example, the cycle life in the case where the E layer is omitted and no modification layer is provided is shown by a broken line. In this case, the cycle life is approximately 250 (hours).

On the other hand, it was found that in the case where magnesium (Mg) was stacked as a modification layer to have a thickness of 50 nm, 100 nm, 200 nm, or 600 nm (x=0.009, 0.018, 0.036, or 0.100), the cycle life was improved in all cases as compared with Comparative Example. Further, it was found that in the case where bismuth (Bi) was stacked as a modification layer to have a thickness of 50 nm, 100 nm, or 200 nm (y=0.006, 0.012, or 0.024), the cycle life was improved in all cases as compared with Comparative Example. Further, it was found that in the case where magnesium (Mg)/bismuth (Bi) were stacked as a modification layer to have a thickness of 200 nm (100 nm each), the cycle life was made longer than that in Comparative Example. For example, in the case where magnesium (Mg)/bismuth (Bi) were stacked as a modification layer to have a thickness of 200 nm, an increase in the cycle life of approximately five times or more was achieved.

Although embodiments of the present disclosure have been described above, it goes without saying that the present disclosure is not limited to the above-mentioned embodiments and various modifications can be made. The respective embodiments are not limited to the independent embodiments and can be combined with each other if technically possible.

What is claimed is:

1. An anode structure applied to an anode of a lithium-ion secondary battery, comprising:
an anode current collector; and
a lithium alloy layer formed on the anode current collector,
the lithium alloy layer having a stoichiometric composition represented by the formula Li_{1-x-y}BiₓMg_{y} (0<x+y≤0.124, 0≤x≤0.024, 0<y≤0.10),
the lithium alloy layer having a thickness of 1 μm or more and 20 μm or less.

2. The anode structure according to claim 1, wherein
the lithium alloy layer has a Young's modulus of 4 GPa or more and 30 GPa or less.

3. The anode structure according to claim 1, wherein
the lithium alloy layer has relative density of 80% or more.

4. The anode structure according to claim 1, wherein
the lithium alloy layer includes a layer with a relatively large content of bismuth.

5. A method of producing an anode structure applied to an anode of a lithium-ion secondary battery, comprising:
forming one of a lithium-containing layer and a modification layer on an anode current collector; and
forming, after forming the one layer, the other of the lithium-containing layer and the modification layer on the one layer,
a magnesium layer, a bismuth layer, a layer containing lithium and magnesium, or a layer containing magnesium and bismuth being used as the modification layer,
an alloy layer having a stoichiometric composition represented by the formula Li_{1-x-y}BiₓMg_{y} (0<x+y≤0.124, 0≤x≤0.024, 0<y≤0.10), the alloy layer being formed on the anode current collector and including the lithium-containing layer and the modification layer,
the alloy layer having a thickness of 1 μm or more and 20 μm or less.

6. The method of producing an anode structure according to claim 5, wherein
the lithium-containing layer contains magnesium.

7. The method of producing an anode structure according to claim 5, further comprising
depositing, where the layer containing magnesium and bismuth is used as the modification layer, one material of magnesium and bismuth and then depositing the other material of magnesium and bismuth.
